(19) United States
(12) Patent Application Publication
(10) Pub. No.: US 2012/0254973 A1
(43) Pub. Date: Oct. 4, 2012

(54) DATA PROTECTION DEVICE FOR COMPUTERS

(75) Inventor: LEI SHI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/169,033

(22) Filed: Jun. 27, 2011

(30) Foreign Application Priority Data
Apr. 2, 2011 (CN) 201110083791.5

(51) Int. Cl. G06F 17/00

(52) U.S. Cl. 726/11

(57) ABSTRACT

A data protection device includes a storage unit, a hard disk drive (HDD) controller, a switch, a network card; and a main control unit. The main control unit prevents the network card from communicating with communication networks when the first switch connects the HDD controller to the storage unit, and directs the first switch to disconnect the HDD controller from the storage unit when the network card is allowed to communicate with the communication networks.

### BACKGROUND

1. Technical Field

The present disclosure relates to data protection devices for computers, and particularly to a data protection device for protecting computers from hacker attacks and computer viruses.

2. Description of Related Art

In network communications, data stored in computers may be stolen or damaged by hacker attacks and computer viruses. Fire-wall software and antivirus software are often installed in most computers in order to protect the computers from hacker attacks and computer viruses. However, purchasing and updating the fire-wall software and antivirus software may be expensive and troublesome, and many computer users are concerned about protecting their private information stored in the computers from being released to, or from being obtained by, suppliers of the fire-wall software and antivirus software. For example, and unbeknown to the computer users, these suppliers may access data stored in the computers using “backdoors” (i.e., programs added to the fire-wall software and antivirus software).

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a block diagram of a data protection device for computers, according to a first exemplary embodiment.

FIG. 2 is a circuit diagram of one embodiment of the control unit of the data protection device shown in FIG. 1, connected to the first switch and the second switch.

FIG. 3 is a block diagram of a data protection device for computers, according to a second exemplary embodiment.

FIG. 4 is a block diagram of a data protection device for computers, according to a third exemplary embodiment.

FIG. 5 is a block diagram of a data protection device for computers, according to a fourth exemplary embodiment.

### DETAILED DESCRIPTION

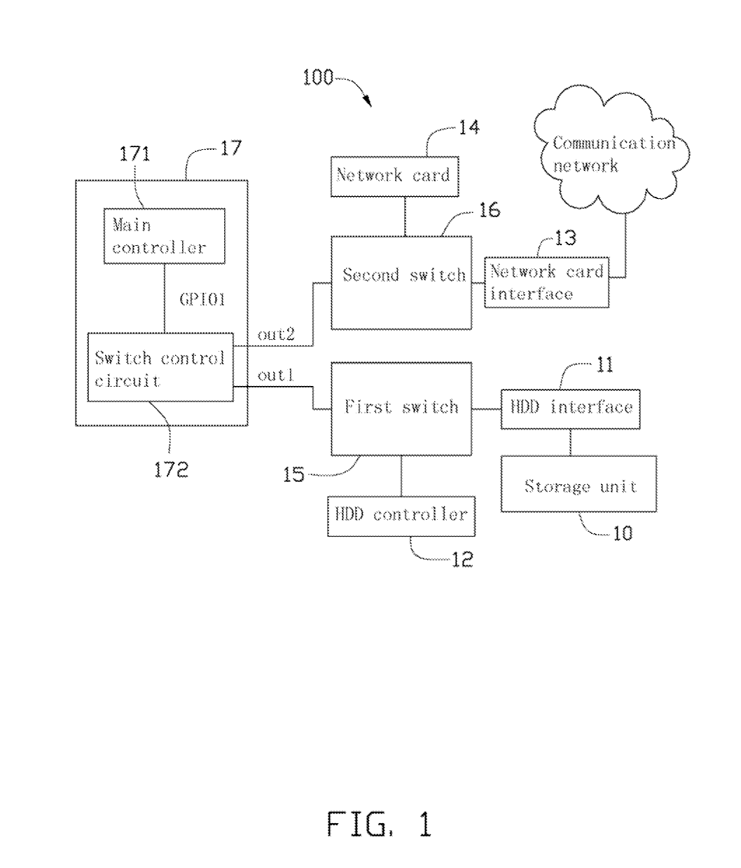

FIG. 1 is a block diagram of a data protection device 100 for computers, according to a first exemplary embodiment. The data protection device 100 can be used in a computer and other communication network terminals, such as a personal digital assistant (PDA), to prevent data stored in the computer from being stolen or damaged by hacker attacks and computer viruses.

The data protection device 100 includes a storage unit 10, a hard disk drive (HDD) interface 11, an HDD controller 12, a network card interface 13, a network card 14, a first switch 15, a second switch 16, and a main control unit 17. The storage unit 10 can be an HDD of a computer, a mobile hard disk, a universal serial bus (USB) mass storage device, etc. Data that needs to be protected, such as private information of users, is stored in the storage unit 10. In use, the storage unit 10 can be integrated with a shared HDD in a computer or other communication network terminal using the data protection device 100.

The first switch 15 is electrically connected to both the HDD controller 12 and the HDD interface 11. When the first switch 15 connects the HDD controller 12 with the HDD interface 11, the HDD controller 12 is connected to the storage unit 10 through the first switch 15 and the HDD interface 11, and thus the storage unit 10 can be accessed using the HDD controller 12.

The network card interface 13 is connected to a typical communication network, such as the Internet. The network card 14 can be a typical network card for accessing the communication network. The second switch 16 is electrically connected to both the network card 14 and the network card interface 13. When the second switch 16 connects the network card 14 with the network card interface 13, the network card 14 can communicate with the communication network through the network card interface 13. In use, the network card 14 is also connected to the inner components (not shown) of the computer, such that all parts of the computer can access the communication network through the network card 14 and the network card interface 13.

The main control unit 17 is electrically connected to both the first switch 15 and the second switch 16 and controls their operations. In particular, the main control unit 17 includes a main controller 171 and a switch control circuit 172 electrically connected to the main controller 171. The main controller 171 can be integrated with a south-bridge chip of the computer, and includes a control pin GPIO1. The main controller 171 can generate at least two types of control signals on the control pin GPIO1, wherein the two types of control signals are respectively a first type of control signal regarded as logic 1 (e.g., having a predetermined higher electric level) and a second type of control signal regarded as logic 0 (e.g., having a predetermined lower electric level).

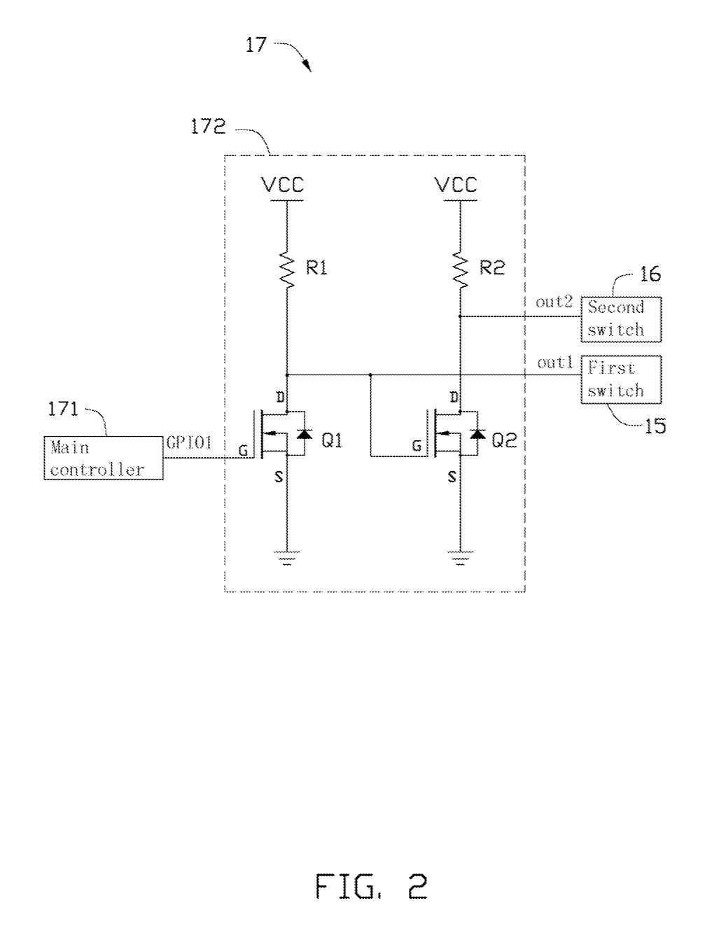

Also referring to FIG. 2, the switch control circuit 172 includes a power supply VCC, two transistors Q1, Q2, two resistors R1, R2, and two output pins out1, out2. Both the two transistors Q1, Q2 are metal-oxide-semiconductor field-effect transistors (MOSFETs). The control pin GPIO1 is electrically connected to a gate of the transistor Q1. A drain of the transistor Q1 is electrically connected to the power supply VCC through the resistor R1, and a source of the transistor Q1 is grounded. The drain of the transistor Q1 is further electrically connected to both the output pin out1 and a gate of the transistor Q2. A drain of the transistor Q2 is electrically connected to the power supply VCC through the resistor R2, and is further electrically connected to the output pin out2. A source of the transistor Q2 is grounded. The output pin out1 and the output pin out2 are electrically connected to the first switch 15 and the second switch 16, respectively.

In use, the main controller 171 generates the control signals, and the control signals are transmitted to the gate of the transistor Q1. When the computer accesses the communication network, the main controller 171 is operated to generate the first type of control signal (i.e., the logic 1 signal having the higher electric level), and the transistor Q1 is turned on by the first type of control signal. Thus, the voltage of the power supply VCC is transmitted to the ground through the resistor R1, the drain of the transistor Q1, and the source of the transistor Q1, and is unable to reach the output pin out1 and the gate of the transistor Q2. Therefore, the first switch 15 receives no voltage from the output pin out1, and the second transistor Q2 remains off. The voltage of the power supply VCC is provided to the second switch 16 through the output pin out2. In this way, the first switch 15 remains off, disconnecting the HDD controller 12 from the storage unit 10, and the second switch 16 is turned on, connecting the network card 14 to the communication network through the second switch 16 and the network card interface 13. Thus, the computer can access the communication network using the network card 14. Since the storage unit 10 is disconnected from the HDD controller 12, although the computer encounters hacker attacks or computer viruses coming from the communication network, the hacker attacks and computer viruses are unable to access the storage unit 10.

When data stored in the storage unit 10 needs to be accessed, the main controller 171 generates the second type of control signal (i.e., the logic 0 signal having the lower electric level), thereby turning off the transistor Q1. The voltage of the power supply VCC is provided to the first switch 15 through the output pin out1, and is also provided to the gate of the transistor Q2 to turn on the transistor Q2. Thus, the voltage of the power supply VCC is transmitted to the ground through the resistor R2, the drain of the transistor Q2, and the source of the transistor Q2, and is unable to reach the output pin out2. In this way, the first switch 15 is turned on to connect the HDD controller 12 with the storage unit 10, and the second switch 16 is turned off to disconnect the network card 14 from the network card interface 13. Thus, the computer can access the storage unit 10 using the HDD controller 10. When the storage unit 10 is accessed, the network card 14 is disconnected from the network card interface 13 to ensure the isolation of the computer from the communication network. Therefore, hacker attacks and computer viruses coming from the communication network are unable to access the storage unit 10.

In the present storage unit 10, the main control unit 17 prevents the first switch 15 and the second switch 16 from being on simultaneously. When either one of the first switch 15 and the second switch 16 is on, the other is forced to be disconnected. Thus, the storage unit 10 is protected from accesses when the network card 14 communicates with communication networks, and the network card 14 is prevented from communicating with the communication networks when the storage unit 10 is being accessed or accessible. In this way, the storage unit 10 cannot be accessed through the communication networks, and thus is protected from hacker attacks and computer viruses coming from the communication networks.

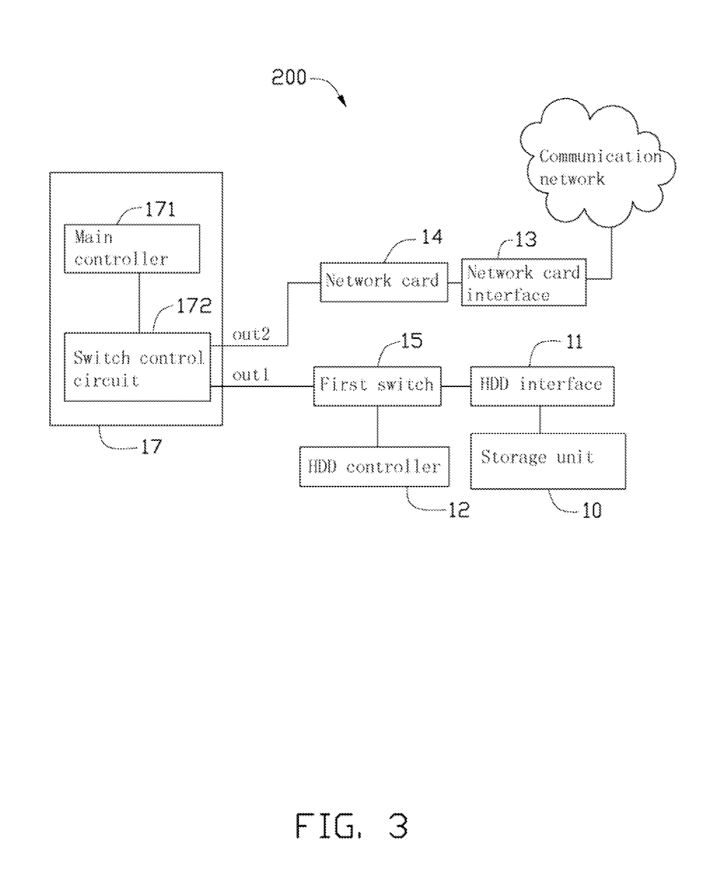

FIG. 3 shows a data protection device 200 for computers, according to a second exemplary embodiment. The data protection device 200 differs from the data protection device 100 in that the second switch 16 is omitted, and the output pin out2 is directly connected to the network card 14. In use, the main control unit 17 enables and disables the network card 14 using the voltage provided to the output pin out2, and thereby ensures that the network card 14 is prevented from communicating with communication networks when the storage unit 10 is accessible (i.e., when the main control unit 17 turns on the first switch 15 as detailed above).

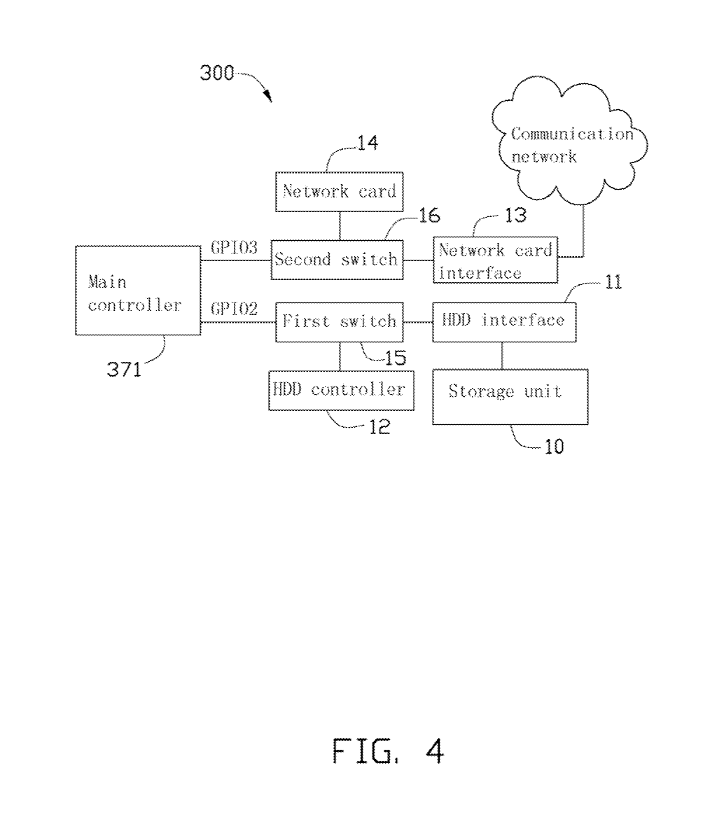

FIG. 4 shows a data protection device 300 for computers, according to a third exemplary embodiment. The data protection device 300 differs from the data protection device 100 in that the switch control circuit 172 is omitted, and the main controller 171 is replaced by a main controller 371. The main controller 371 differs from the main controller 171 in that the main controller 371 includes two control pins GPIO 2 and GPIO3. The control pins GPIO2 and GPIO3 are respectively connected to the first switch 15 and the second switch 16. The main controller 371 generates the high and low control signals on the control pins GPIO2 and GPIO3 for controlling the first switch 15 and the second switch 16 to be turned on and off, and thereby ensures that the second switch 16 disconnects when the first switch 15 connects, that is, the network card 14 is prevented from communicating with communication networks when the storage unit 10 is accessible.

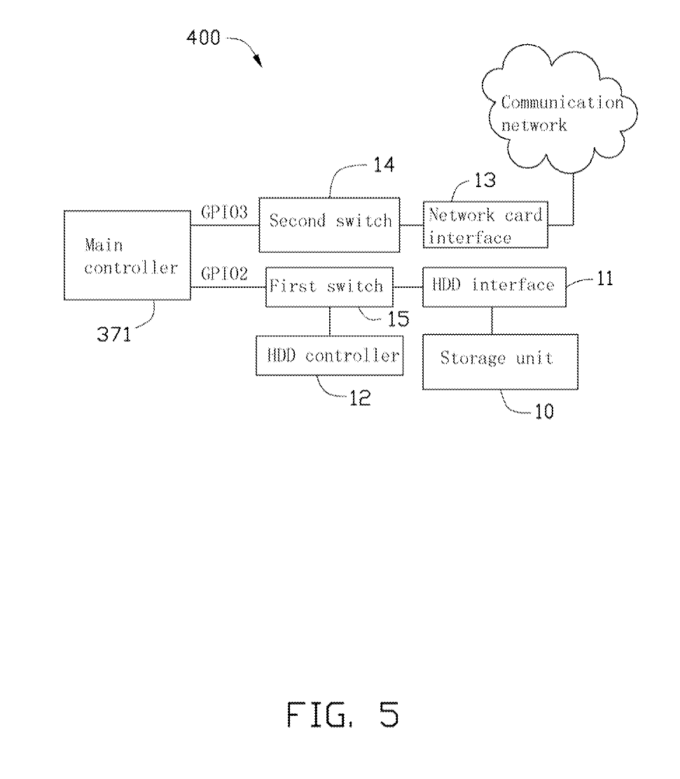

FIG. 5 shows a data protection device 400 for computers, according to a fourth exemplary embodiment. The data protection device 400 differs from the data protection device 300 in that the second switch 16 is omitted, and the control pin GPIO3 is directly connected to the network card 14. In use, the main controller 371 enables and disables the network card 14 using the control signals generated on the control pin GPIO3, and thereby ensures that the network card 14 is prevented from communicating with communication networks when the storage unit 10 is accessible (i.e., when the main controller 371 turns on the first switch 15 using the control signals generated on the control pin GPIO2).

Even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A data protection device for a communication network terminal, comprising:
a storage unit;
a hard disk drive (HDD) controller;
a first switch connected to both the HDD controller and the storage unit;
a network card; and
a main control unit connected to the first switch and the network card; wherein the main control unit prevents the network card from communicating with communication networks when the main control unit controls the first switch to connect the HDD controller to the storage unit using the first switch for accessing the storage unit, and controls the first switch to disconnect the HDD controller from the storage unit when the main control unit allows the network card to communicate with the communication networks.

2. The data protection device as claimed in claim 1, wherein the main control unit enables the network card to allow the network card to communicate with the communication networks, and disables the network card to prevent the network card from communicating with the communication networks.

3. The data protection device as claimed in claim 1, wherein the main control unit includes a main controller that generates control signals to control the first switch to connect and disconnect, and to allow and prevent the network card communicating with the communication networks.

4. The data protection device as claimed in claim 3, wherein the main control unit further includes a switch control circuit; the switch control circuit including a power supply, two transistors, two resistors, and two output pins; both the two transistors being metal-oxide-semiconductor field-effect transistors (MOSFETs), the main controller connected to a gate of one of the transistors, a drain of the one of the transistors connected to the power supply through one of the resistors, and a source of the one of the transistors grounded; the drain of the one of the transistor further connected to both one of the output pins and a gate of the other of the transistors, a drain of the other of the transistors connected to the power supply through the other of the resistors, and further connected to the other of the output pins, a source of the other of the transistors grounded; the two output pins respectively connected to the first switch and the network card.

5. The data protection device as claimed in claim 4, wherein when the main controller provides a first type of control signal to the gate of the one of the transistors, different voltages are respectively provided to the first switch and the network card through the two output pins, thereby preventing the network card from communicating with the communication networks and simultaneously controlling the first switch to connect the HDD controller with the storage unit for accessing the storage unit; when the main control unit provides a second type of control signal to the gate of the one of the transistors, different voltages are respectively provided to the first switch and the network card through the two output pins, thereby controlling the first switch to disconnect the HDD controller from the storage unit and simultaneously allowing the network card to communicate with the communication networks.

6. The data protection device as claimed in claim 5, wherein the main controller is integrated with a south-bridge chip.

7. The data protection device as claimed in claim 1, further comprising a second switch connected to the network card, the communication networks, and the main control unit; wherein the main control unit controls the second switch to connect the network card with the communication networks and disconnect the network card from the communication networks, thereby respectively allowing and preventing the network card communicating with the communication networks.

8. A data protection device for a communication network terminal, comprising:
a hard disk drive (HDD) controller;
a first switch for connecting the HDD controller to a storage unit;
a network card; and
a main control unit connected to the first switch and the network card; wherein the main control unit preventing the network card from communicating with communication networks when the main control unit controls the first switch to connect the HDD controller to the storage unit for accessing the storage unit, and controls the first switch to disconnect the HDD controller from the storage unit when the main control unit allows the network card to communicate with the communication networks.

9. The data protection device as claimed in claim 8, wherein the main control unit enables the network card to allow the network card to communicate with the communication networks, and disables the network card to prevent the network card from communicating with the communication networks.

10. The data protection device as claimed in claim 8, wherein the main control unit includes a main controller that generates control signals to control the first switch to connect and disconnect, and to allow and prevent the network card communicating with the communication networks.

11. The data protection device as claimed in claim 10, wherein the main control unit further includes a switch control circuit; the switch control circuit including a power supply, two transistors, two resistors, and two output pins; both the two transistors being metal-oxide-semiconductor field-effect transistors (MOSFETs), the main controller connected to a gate of one of the transistors, a drain of the one of the transistors connected to the power supply through one of the resistors, and a source of the one of the transistors grounded; the drain of the one of the transistor further connected to both one of the output pins and a gate of the other of the transistors, a drain of the other of the transistors connected to the power supply through the other of the resistors, and further connected to the other of the output pins, a source of the other of the transistors grounded; the two output pins respectively connected to the first switch and the network card.

12. The data protection device as claimed in claim 11, wherein when the main controller provides a first type of control signal to the gate of the one of the transistors, different voltages are respectively provided to the first switch and the network card through the two output pins, thereby preventing the network card from communicating with the communication networks and simultaneously controlling the first switch to connect the HDD controller with the storage unit for accessing the storage unit; when the main control unit provides a second type of control signal to the gate of the one of the transistors, different voltages are respectively provided to the first switch and the network card through the two output pins, thereby controlling the first switch to disconnect the HDD controller from the storage unit and simultaneously allowing the network card to communicate with the communication networks.

13. The data protection device as claimed in claim 12, wherein the main controller is integrated with a south-bridge chip.

14. The data protection device as claimed in claim 8, further comprising a second switch connected to the network card, the communication networks, and the main control unit; wherein the main control unit controls the second switch to connect the network card with the communication networks and disconnect the network card from the communication networks, thereby respectively allowing and preventing the network card communicating with the communication networks.
